(19) United States
(12) Patent Application Publication
(10) Pub. No.: US 2009/0060039 A1
(43) Pub. Date: Mar. 5, 2009

(54) METHOD AND APPARATUS FOR COMPRESSION-ENCODING MOVING IMAGE

(76) Inventors: Yasuharu Tanaka, Osaka (JP); Shinji Kitamura, Kyoto (JP)

Correspondence Address: MCDERMOTT WILL & EMERY LLP, 600 13TH STREET, NW, WASHINGTON, DC, 20005-3096, US

(21) Appl. No.: 12/190,156

(22) Filed: Aug. 12, 2008

(30) Foreign Application Priority Data
Sep. 5, 2007 (JP) 2007-229995
Jun. 16, 2008 (JP) 2008-156761

(51) Int. Cl. H04N 11/02

(52) U.S. Cl. 375/240.13; 375/E07.076

(57) ABSTRACT

Encoding processes are performed in their respective encoding modes until their respective quantized DCT (discrete cosine transform) coefficients are generated. Based on information about code amounts generated in the encoding modes, an encoding mode that provides a smallest code amount is determined. DCT coefficients corresponding to the determined encoding mode are subjected to variable-length encoding.

### BACKGROUND OF THE INVENTION

1. Field of the Invention

The present invention relates to apparatuses having a function of taking a moving image, such as a digital camera, a mobile telephone with camera and the like, and to moving image compression-encoding techniques for creating and using image contents.

2. Description of the Related Art

In recent years, commercialization of highly efficient moving image compression-encoding techniques, such as MPEG (moving picture experts group) and the like, has rapidly penetrated into camcorders, mobile telephones and the like.

In standards for encoding techniques, such as MPEG or the like, various encoding modes are defined. For example, MPEG-4 has an “intra-encoding mode” in which only an image in a screen of a frame to be encoded is used and encoded (hereinafter referred to as a target image), and an “inter-encoding mode” in which an image region that strongly correlates with a target image is detected (motion estimation) from a frame that has already been encoded (hereinafter referred to as a reference frame), and only a difference value between an image after motion estimation (hereinafter referred to as a motion-compensated image) and the target image is encoded.

In MPEG-4AVC/H.264, pixel prediction (hereinafter referred to as intra-prediction) that employs pixels in a screen can be performed in intra-encoding, and a plurality of intra-prediction modes are defined for each of luminance and color difference signals. Also in inter-encoding, a reference frame can be selected from a plurality of candidates, and a block size of an image in which motion compensation is performed can be selected from various modes ranging from 16 pixels×16 pixels (maximum) to 4 pixels×4 pixels (minimum).

For example, mode determination of the intra-encoding mode/the inter-encoding mode in MPEG-4 is commonly performed by a method as shown in FIG. 16.

In the conventional mode determining method of FIG. 16, initially, a motion-compensated image to be used in the inter-encoding mode is detected and generated from a reference frame (S100). The motion-compensated image and a target image are used to calculate SAD and ACT (S101) by:

SAD=ΣΣ|target image(org_x, org_y)—motion-compensated image(ref_x, ref_y)|

ACT=ΣΣ|target image(org_x, org_y)—an average value of the target image|.

SAD is calculated using all pixels in a macroblock (16 pixels×16 pixels) that is an encoding unit of MPEG-4. Absolute difference values are calculated on a pixel-by-pixel basis from the upper left pixels of the target image and the motion-compensated image, and the sum of the absolute difference values of a total of 256 pixels (16 pixels×16 pixels) is SAD.

ACT is also calculated using all pixels in the macroblock. Initially, an average of 256 pixels in the target image is calculated, and thereafter, absolute difference values from the average are calculated on a pixel-by-pixel basis from the upper left pixel of the target image, and the sum of the absolute difference values of the 256 pixels is ACT.

SAD and ACT are used as evaluation values to determine an encoding mode. When SAD<ACT, the inter-encoding mode is selected, and when SAD≧ACT, the intra-encoding mode is selected (S102).

FIG. 17 is a diagram showing a configuration of an encoder 200 that uses SAD and ACT. According to FIG. 17, a target image to be encoded is externally input to a motion estimating section 201. Image data of a previous frame required for motion estimation is also input from a reference frame storing section 213 to the motion estimating section 201. The motion estimating section 201 performs motion estimation using these pieces of image data and outputs a result of the motion estimation to a motion-compensated image generating section 202. The motion-compensated image generating section 202 receives the result and generates a motion-compensated image from the reference frame and outputs the motion-compensated image to a subtraction section 203. The subtraction section 203 calculates a difference between the target image input to the encoder 200 and the motion-compensated image and outputs the difference as a difference image to an encoding mode selecting section 204.

Also, the target image input to the encoder 200 is input to an ACT calculating section 250 and an SAD calculating section 251, and the motion-compensated image generated in the motion-compensated image generating section 202 is input to the SAD calculating section 251, so that SAD and ACT are calculated and input to an encoding mode determining section 252. The encoding mode determining section 252 selects an encoding mode having the smaller one of these values, and outputs the result of the selection, i.e., the “intra-encoding mode” or the “inter-encoding mode”, to the encoding mode selecting section 204.

The encoding mode selecting section 204 receives the target image input to the encoder 200, the difference image generated by the subtraction section 203, and the encoding mode determined by the encoding mode determining section 252.

If the encoding mode determining section 252 determines that the “intra-encoding mode” should be used, the encoding mode selecting section 204 selects the target image. If the encoding mode determining section 252 determines that the “inter-encoding mode” should be used, the encoding mode selecting section 204 selects and outputs the difference image to a DCT (discrete cosine transform) processing section 205. The DCT processing section 205 performs a DCT process and outputs the result to a quantization processing section 206. The quantization processing section 206 performs a quantization process and outputs the result to a variable-length encoding section 209 and an inverse quantization processing section 207. The inverse quantization processing section 207 performs inverse quantization with respect to data received after the quantization process (hereinafter referred to as DCT coefficients) and outputs the result to an inverse DCT processing section 208. The inverse DCT processing section 208 performs an inverse DCT process. If the encoding mode determining section 252 has selected the “inter-encoding mode”, the motion-compensated image is added to the data after the inverse DCT process. The switching is performed in a motion compensation switching section 211, and the addition is performed in an addition section 212. An image output from the addition section 212 (hereinafter referred to as a reconstructed image) is temporarily stored as a reference image for the next frame or thereafter in the reference frame storing section 213, for use in a subsequent frame.

The variable-length encoding section 209 performs a variable-length encoding process with respect to the DCT coefficients generated by the quantization processing section 206, to generate a stream. The stream is temporarily stored in a stream storing section 210 and is subsequently output as a generated stream from the encoder 200.

An encoding mode determining technique employing a target image and a motion-compensated image that is similar to that described above has also been disclosed in Japanese Unexamined Patent Application Publication No. 2002-159012.

### SUMMARY OF THE INVENTION

In the above-described encoding mode determining technique, the amount of final codes generated is not taken into consideration during encoding mode determination, and therefore, more codes may be generated in the selected encoding mode. For example, it is assumed that the intra-encoding mode is selected since SAD>>ACT. However, it may be well expected that the actual amount of codes in a stream that has been subjected to an encoding process is such that “the amount of codes in the intra-encoding mode” >>“the amount of codes in the inter-encoding mode”.

Hereinafter, a specific example will be described. FIG. 18 shows a target image to be encoded, and motion-compensated pixel data after motion estimation. Note that, for the sake of convenience, the target image size, the motion compensation size, the image size in SAD calculation, the image size in ACT calculation, and the process size in DCT are here all assumed to be 4 pixels×4 pixels.

Here, for the target image and the motion-compensated image, ACT is “180” and SAD is “2400”, so that SAD>>ACT. Considering the sequences of encoding steps in the intra-encoding mode and the inter-encoding mode when these images are used, however, coefficients are distributed in all frequency bands when the target image is subjected to a DCT process in the intra-encoding mode (see FIG. 19). In the inter-encoding mode, when a difference value between the target image and the motion-compensated image is initially obtained and is then subjected to the DCT process, data is generated only in DC component, while all AC components take a value of “0” (see FIG. 19). Although a quantization process is performed after the DCT process, it is assumed that the compression ratio is very low (quantization value=1), i.e., “data before quantization”=“data after quantization”.

Thereafter, a variable-length encoding process is performed with respect to the data after quantization. Since a variable-length encoding process is typically performed only with respect to data after quantization other than “0” (hereinafter referred to as non-0 data), the amount of codes is larger in an encoding mode in which a larger amount of non-0 data is included. In this example, it can be easily expected that “the number of pieces of non-0 data in the intra-encoding mode”>>“the number of pieces of non-0 data in the inter-encoding mode”, resulting in “the amount of codes in the intra-encoding mode”>>“the amount of codes in the inter-encoding mode”.

Thus, it is sufficiently possible in an encoding process that “the amount of codes in the intra-encoding mode”>>“the amount of codes in the inter-encoding mode” irrespective of SAD>>ACT.

On the other hand, when an encoding process is performed, aiming a certain bit rate, then if the amount of codes temporarily increases in a certain frame (or a macroblock), it is required to absorb the increased amount of codes in the next frame (or the next macroblock) and thereafter. For example, assuming that two frames of images are encoded at a rate of 2 Mbps (bits per second), i.e., 2 fps (frames per second), the following two types of encoding processes will be compared.

An encoding process A in which 1 Mbits of codes are generated in the first frame and 1 Mbits of codes are also generated in the second frame on the average, is compared with an encoding process B in 1.999 Mbits of codes are generated in the first frame and 0.001 Mbits of codes are generated in the second frame to seek 2 Mbps. In comparison about the first frame, the amount of codes in the encoding process B is about two times lager than in the encoding process A, so that a higher level of image quality is considered to be obtained in the encoding process B. In comparison about the second frame, the image quality is considered to be lower in the encoding process B in which only a very small amount of codes is generated. In other words, whereas both the two frames have an average level of image quality in the encoding process A, one frame has a high level of image quality while the next frame has a low level of image quality in the encoding process B, so that such a large difference in image quality between frames may lead to a low-quality moving image.

As described above, in conventional methods for determining an encoding mode, the amount of codes is not taken into consideration. Therefore, when encoding is performed in a selected encoding mode, the amount of codes generated therein may be larger than when encoding is performed in another encoding mode, resulting in a hindrance to efforts to improve image quality and a compression ratio.

The present invention is characterized in that, in image compression in which there are a plurality of encoding modes, an encoding process is performed in each of the plurality of encoding modes until quantized DCT coefficients are generated, an encoding mode that provides a smallest code amount is determined based on information about the amount of codes to be generated in each encoding mode, and DCT coefficients of the determined encoding mode are selected and subjected to variable-length encoding.

According to the present invention, when an encoding mode is selected from a plurality of encoding modes, an encoding mode that provides a smallest code amount can be invariably and correctly selected. In addition, by selecting and subjecting DCT coefficients of the determined encoding mode to variable-length encoding, the size of an encoding process device can be reduced.

### BRIEF DESCRIPTION OF THE DRAWINGS

FIG. 1 is a block diagram showing an encoding process device according to an embodiment of the present invention.

FIG. 2 is a block diagram showing an encoding section of FIG. 1.

FIG. 3 is a block diagram of the encoding process device of FIG. 2 where n=2.

FIG. 4 is a diagram showing a block size with which a DCT process, a quantization process, and a code amount calculating process are performed.

FIGS. 5A, 5B and 5C are diagrams showing timing of a DCT process, a quantization process, and a code amount calculating process.

FIG. 6 is a block diagram showing an encoding process device comprising an encoding mode determining section for determining an intra-prediction mode which provides a smallest code amount.

FIG. 7 is a block diagram showing an encoding section of FIG. 6.

FIG. 8 is a block diagram showing an encoding process device comprising an encoding mode determining section for determining a reference frame which provides a smallest code amount.

FIG. 9 is a block diagram showing an encoding section of FIG. 8.

FIG. 10 is a block diagram showing an encoding process device comprising an encoding mode determining section for determining a block size for motion compensation which provides a smallest code amount.

FIG. 11 is a block diagram showing an encoding section of FIG. 10.

FIG. 12 is a block diagram showing an encoding process device that achieves an adaptive quantization value.

FIG. 13 is a block diagram showing an encoding section of FIG. 12.

FIG. 14 is a diagram showing a relationship between frame encoding types and quantization values.

FIG. 15 is a block diagram showing a configuration of an imaging system employing the encoding process device of the present invention.

FIG. 16 is a flow chart showing a conventional mode determining technique.

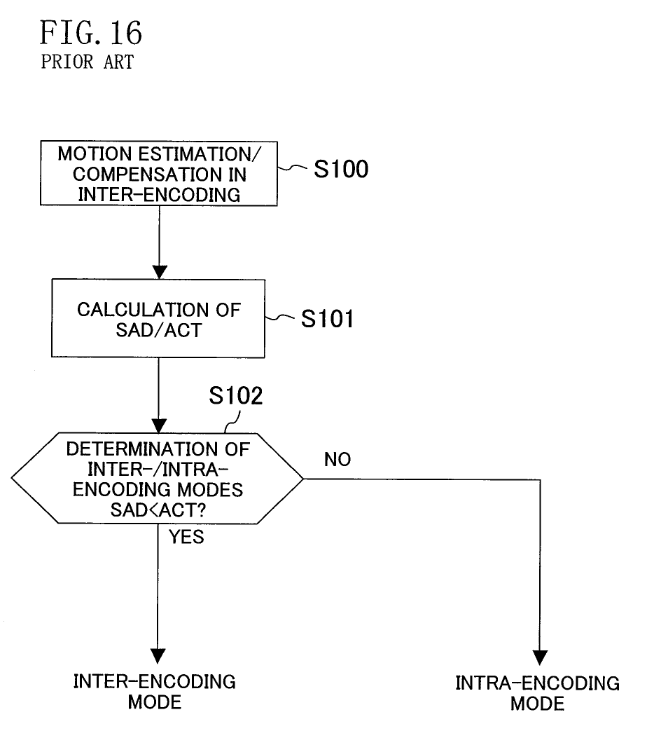

FIG. 17 is a diagram showing a configuration of an encoder employing SAD and ACT.

FIG. 18 is a diagram showing a target image to be encoded, and motion-compensated pixel data after motion estimation.

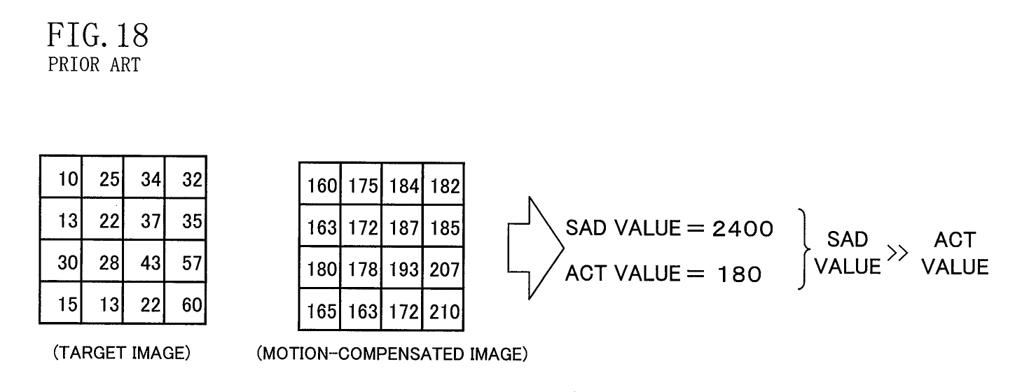

FIG. 19 is a diagram showing data resulting from a DCT process.

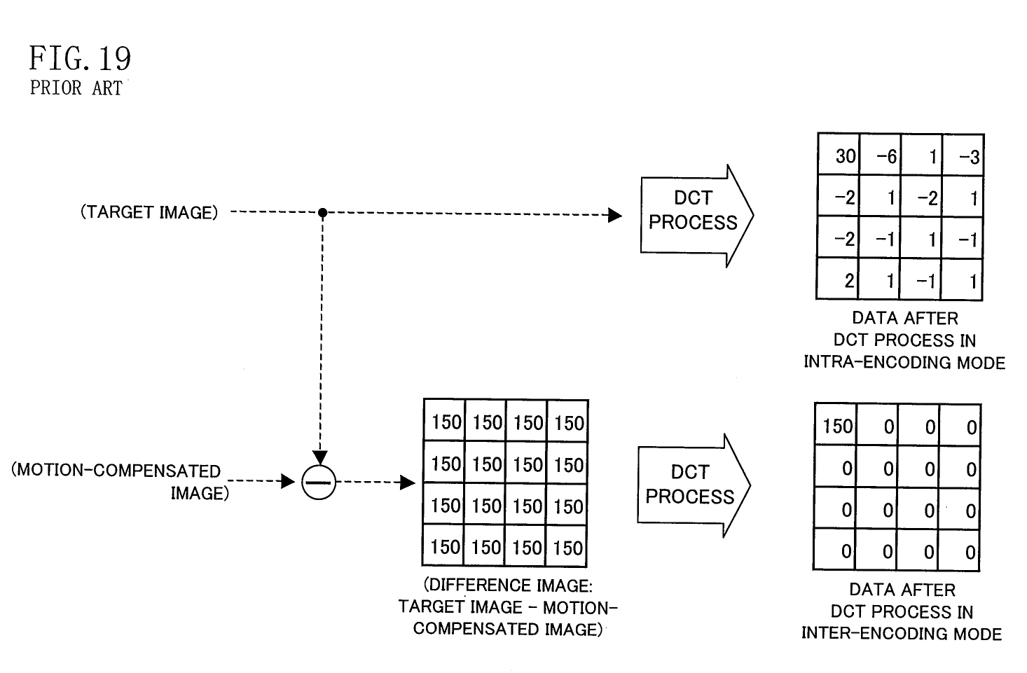

### DETAILED DESCRIPTION OF THE PREFERRED EMBODIMENTS

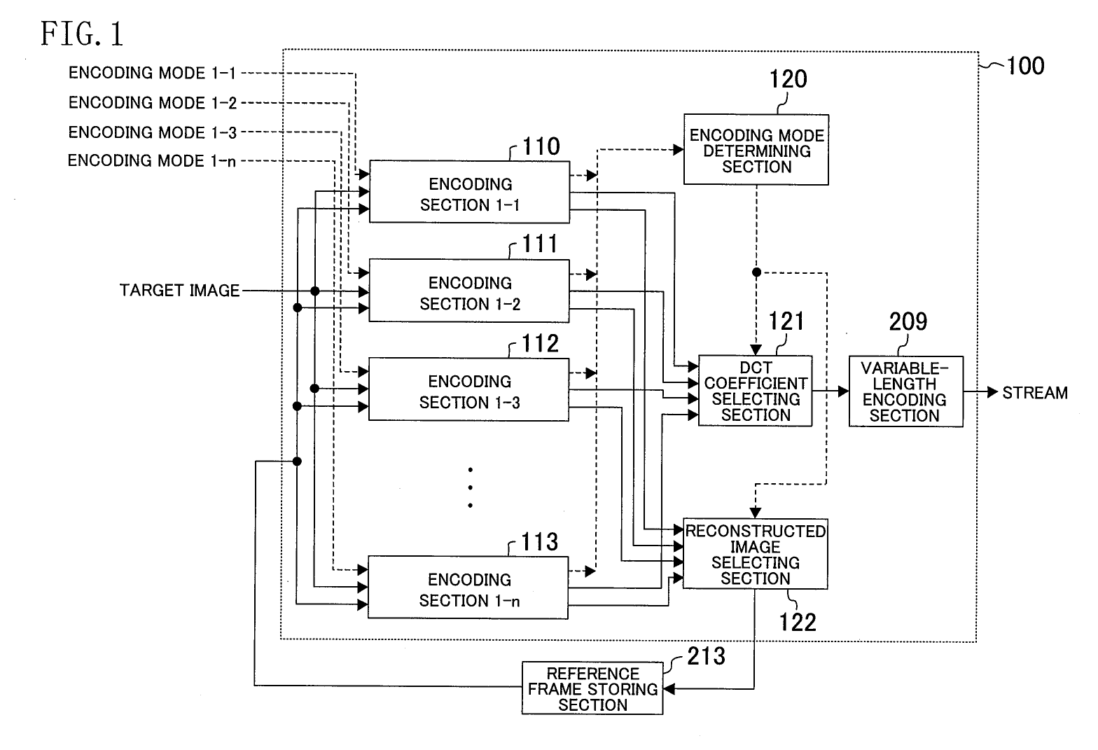

FIG. 1 is a block diagram showing an encoding process device according to an embodiment of the present invention. The encoding process device 100 comprises a first encoding section 1-1 (110), a second encoding section 1-2 (111), a third encoding section 1-3 (112), . . . , and an n-th encoding section 1-n (113), corresponding to n (n is an integer of 2 or more) respective encoding modes, an encoding mode determining section 120, a DCT coefficient selecting section 121, a reconstructed image selecting section 122, and a variable-length encoding section 209.

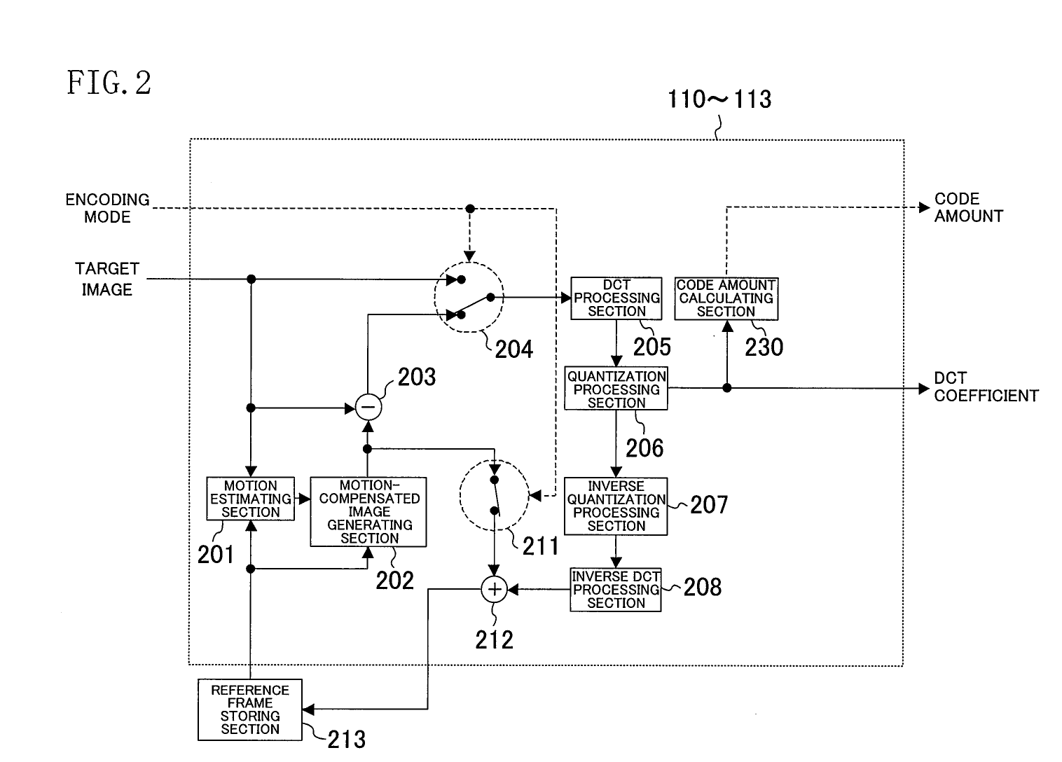

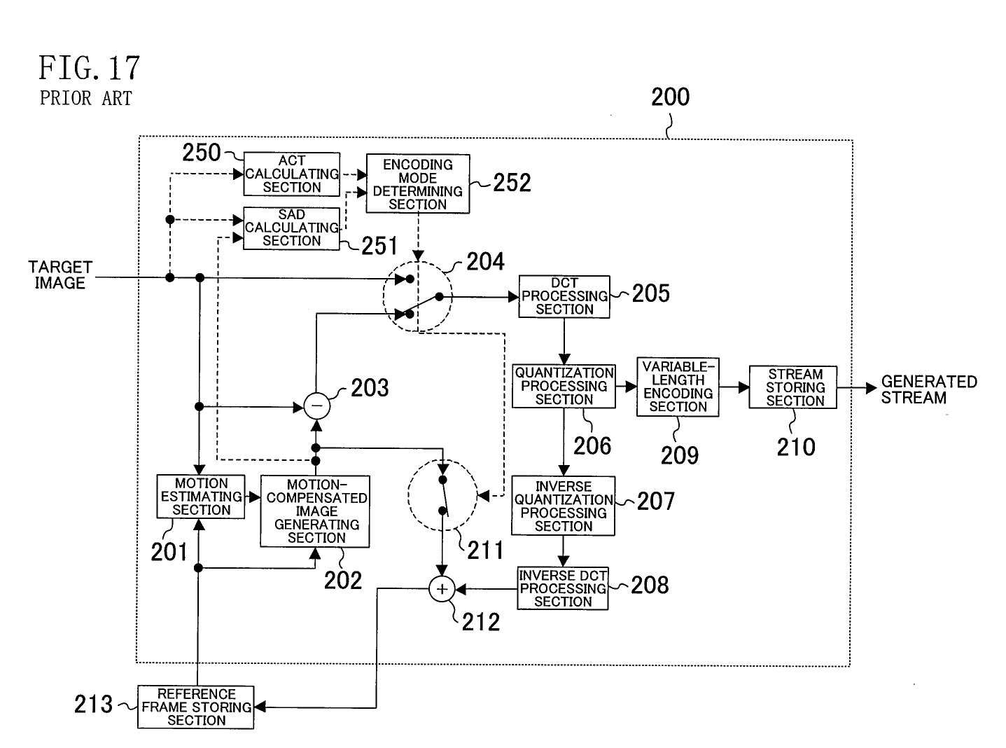

FIG. 2 shows a configuration of each of the encoding section 1-1 (110) to the encoding section 1-n (113) of FIG. 1, which is the same as that of the block diagram of FIG. 17, except that the ACT calculating section 250, the SAD calculating section 251, the encoding mode determining section 252, the variable-length encoding section 209 and the stream storing section 210 are removed, and a code amount calculating section 230 is added. An encoding mode, which is conventionally determined by the encoding mode determining section 252, is externally input to the encoding sections 110 to 113. Therefore, each of the encoding sections 110 to 113 receives a target image to be encoded and image data of a previous frame, and executes an encoding process in a predetermined encoding mode that is externally input thereto. Also, each of the encoding sections 110 to 113 does not comprise the variable-length encoding section 209, and only one variable-length encoding section 209 is provided in the encoding process device 100. Each of the encoding sections 110 to 113 outputs DCT coefficients that are generated by the quantization processing section 206 instead of a stream. These quantized DCT coefficients are input to the coefficient selecting section 121, which selects DCT coefficients output from an encoding section that has been determined by the encoding mode determining section 120. The selected DCT coefficients are subjected to a variable-length encoding process in the variable-length encoding section 209 and the result is output as a stream from the encoding process device 100.

Note that each of the encoding sections 110 to 113 needs to output the amount of codes to the encoding mode determining section 120, and hence needs to additionally include the code amount calculating section 230 for calculating only the code amount from DCT coefficients instead of the variable-length encoding section 209. The code amount calculating section 230 may have only a function of calculating the amount of codes, and therefore, requires a smaller size than that of the variable-length encoding section 209.

Also, each of the encoding sections 110 to 113 does not generate an encoded stream, and therefore, does not need to include the stream storing section 210. The stream storing section 210 needs to have a capacity that can store at least one macroblock of stream. However, a variable-length encoding process cannot necessarily compress data. In other words, a generated stream does not necessarily have a smaller data size than that of an input image. Therefore, the stream storing section 210 often has a capacity with a margin. However, since the stream storing section 210 can be removed from the encoding process device 100 of the present invention, the size of the encoding process device 100 can be significantly reduced.

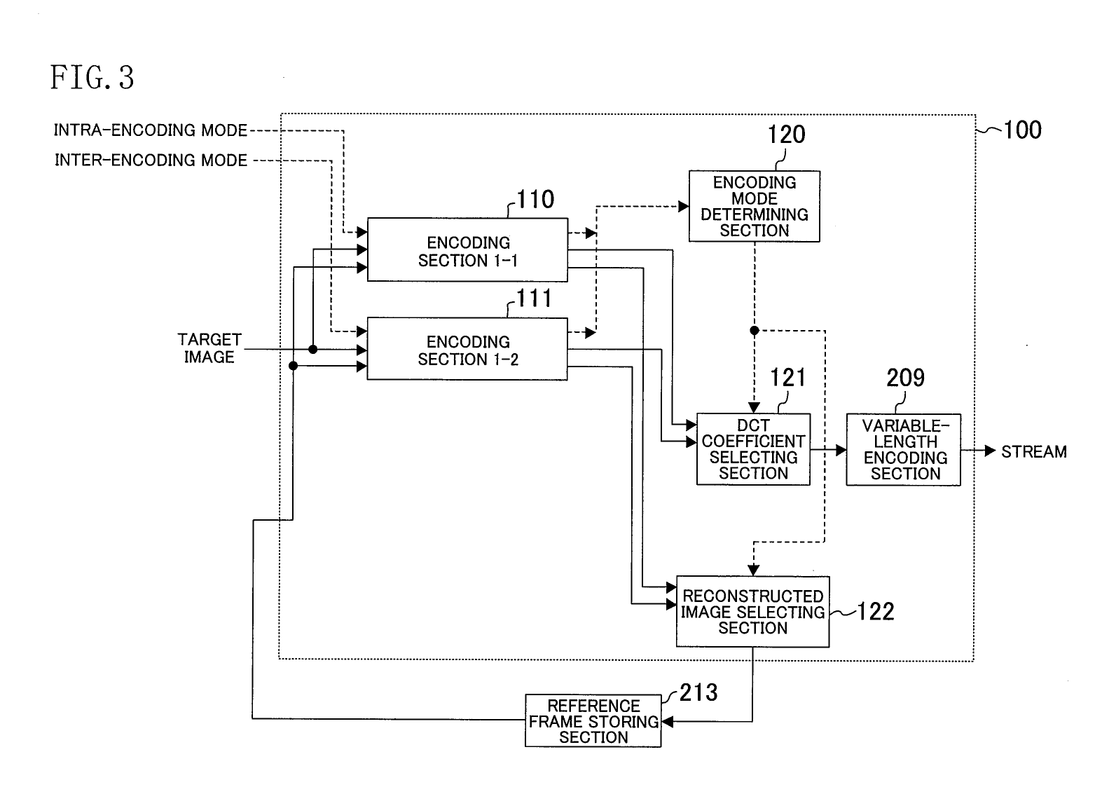

FIG. 3 is a block diagram of the encoding process device 100 where n=2. Here, optimal determination of an encoding mode in view of the amount of codes will be described, assuming that an encoding mode input to the first encoding section 1-1 (110) is the “intra-encoding mode” and an encoding mode input to the second encoding section 1-2 (111) is the “inter-encoding mode”.

Since the first encoding section 1-1 (110) operates in the intra-encoding mode, the encoding mode selecting section 204 of FIG. 2 selects a target image. Specifically, DCT coefficients that are generated with respect to the target image via the DCT processing section 205 and the quantization processing section 206, are output to the outside of the encoding section 1-1 (110). On the other hand, a reconstructed image that is generated via the inverse quantization processing section 207 and the inverse DCT processing section 208, is also output to the outside of the first encoding section 1-1 (110).

Since the second encoding section 1-2 (111) operates in the inter-encoding mode, the encoding mode selecting section 204 of FIG. 2 selects a difference image output from the subtraction section 203. Specifically, DCT coefficients that are generated with respect to the difference image via the DCT processing section 205 and the quantization processing section 206, are output to the outside of the second encoding section 1-2 (111). On the other hand, a reconstructed image that is generated via the inverse quantization processing section 207, the inverse DCT processing section 208, and the addition section 212, is also output to the outside of the second encoding section 1-2 (111).

A code amount output from the first encoding section 1-1 (110) and a code amount output from the second encoding section 1-2 (111) are input to the encoding mode determining section 120. In view of these code amounts, the encoding mode determining section 120 determines an encoding section that has performed an encoding process in an encoding mode which provides a smallest code amount, and outputs the result to the DCT coefficient selecting section 121 and the reconstructed image selecting section 122. The DCT coefficient selecting section 121 supplies, to the variable-length encoding section 209, quantized DCT coefficients that have been obtained from the quantization processing section 206 of the encoding section selected by the encoding mode determining section 120. The variable-length encoding section 209 outputs the result of a variable-length encoding process as a stream from the encoding process device 100. The reconstructed image selecting section 122 reads a reconstructed image from the addition section 212 in the encoding section selected by the encoding mode determining section 120, and writes the reconstructed image to the reference frame storing section 213 provided outside the encoding process device 100.

Specifically, the amount of codes in a stream to be processed and generated in the intra-encoding mode in the first encoding section 1-1 (110) is compared with the amount of codes in a stream to be processed and generated in the inter-encoding mode in the second encoding section 1-2 (111), and an encoding mode that results in the smaller code amount is selected, thereby making it possible to execute an encoding process invariably using an encoding mode that provides the smaller code amount.

The encoding process device 100 of FIGS. 1 and 2 does not need to include a plurality of variable-length encoding sections 209 or a plurality of stream storing sections 210, resulting in a reduction in size. However, the amount of codes needs to be calculated by the code amount calculating section 230 provided between the quantization processing section 206 and the variable-length encoding section 209. Therefore, a longer process time is required. This can be overcome by the following method.

In the DCT processing section 205, the quantization processing section 206, and the code amount calculating section 230, the size of a block processed is the same. For example, if the size of a block processed in the DCT processing section 205 is 8 pixels×8 pixels, the size of a block processed in the quantization processing section 206 and the code amount calculating section 230 is also 8 pixels×8 pixels.

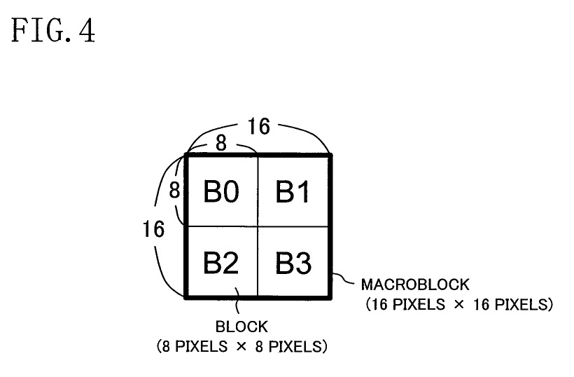

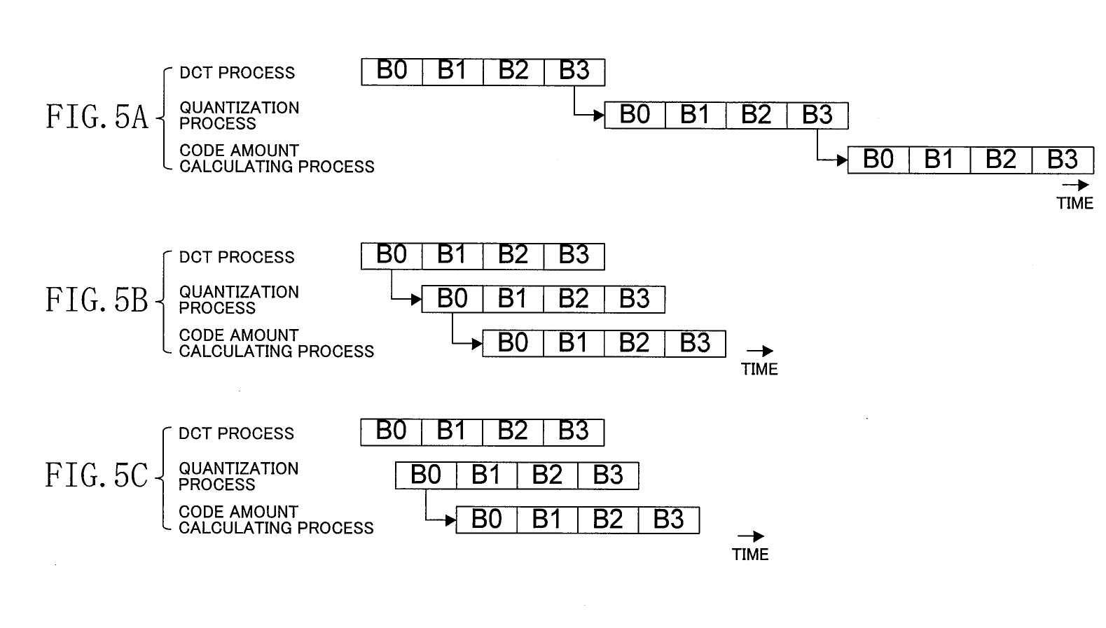

As shown in FIG. 4, when a macroblock is composed of 16 pixels×16 pixels, a block process is performed in four blocks (B0 to B3). Although a DCT process, a quantization process, and a code amount calculating process may be sequentially performed in a macroblock-by-macroblock basis as shown in FIG. 5A, processing speed can be increased by executing the processes in block-level pipelines as shown in FIG. 5B. Also, as shown in FIG. 5C, processing speed can be further increased by executing the quantization process with respect to each pixel immediately after the DCT process has been performed with respect to the pixel.

The present invention is also applicable to determination of an intra-prediction mode that is defined in a moving image compression-encoding technique, such as, representatively, MPEG-4AVC/H.264. Here, intra-prediction will be described.

In an intra-encoding mode process, initially, an intra-prediction image is generated using images of surrounding blocks, a difference image between a target image and the intra-prediction image is generated, and the difference image is subjected to a DCT process or the like. A stronger correlation between a target image and an intra-prediction image, i.e., a smaller difference image, has a higher encoding efficiency. For the method for generating an intra-prediction image using images of surrounding blocks, several modes are defined. For example, there are nine modes for prediction of a luminance signal when the prediction block size is 4×4. Among them are an “intra-prediction mode 0” in which four pixels at a lower end of an upper adjacent block are used to generate an intra-prediction image, an “intra-prediction mode 1” in which four pixels at a right end of a left adjacent block are used to generate an intra-prediction image, and the like.

Also, for luminance, four modes are defined for 16×16, and nine modes are defined for 8×8, in addition to the prediction block size of 4×4. For color difference, four modes are defined for 8×8.

If a prediction block size is changed or an intra-prediction mode used is changed, a different intra-prediction image is generated and a different stream is also generated. In other words, the amount of codes itself varies depending on the prediction block size or the intra-prediction mode.

The present invention is also applicable when an encoding process is performed in the intra-prediction mode determination while invariably selecting a mode which provides a smallest code amount.

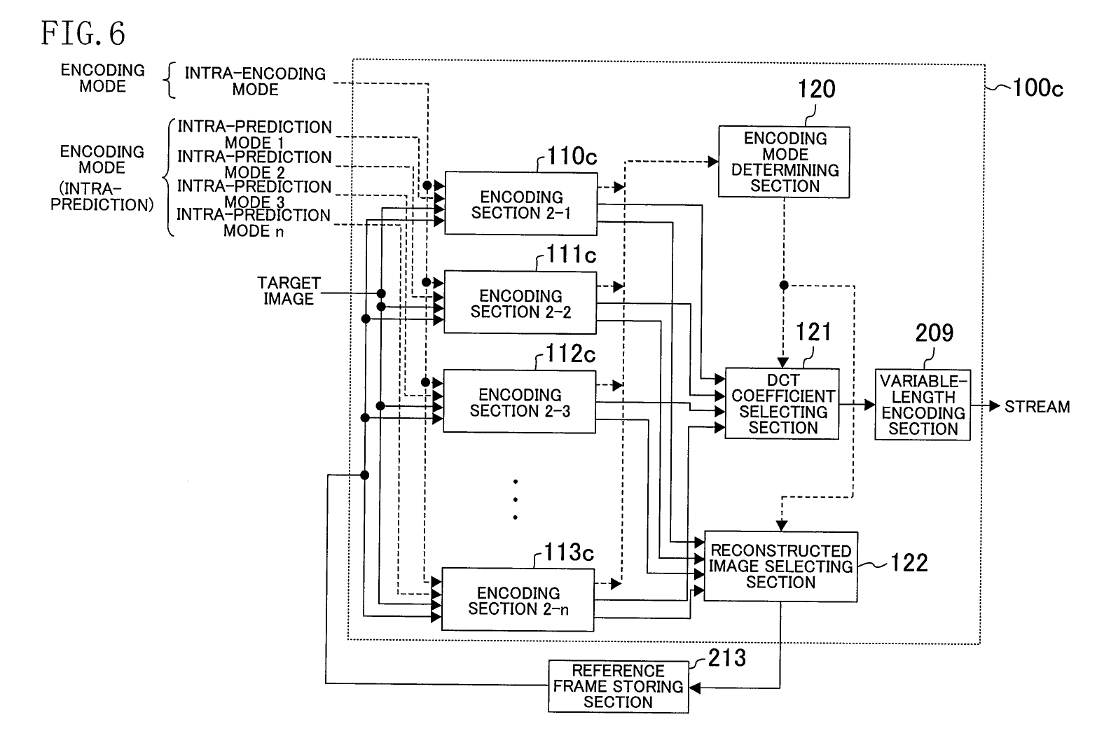

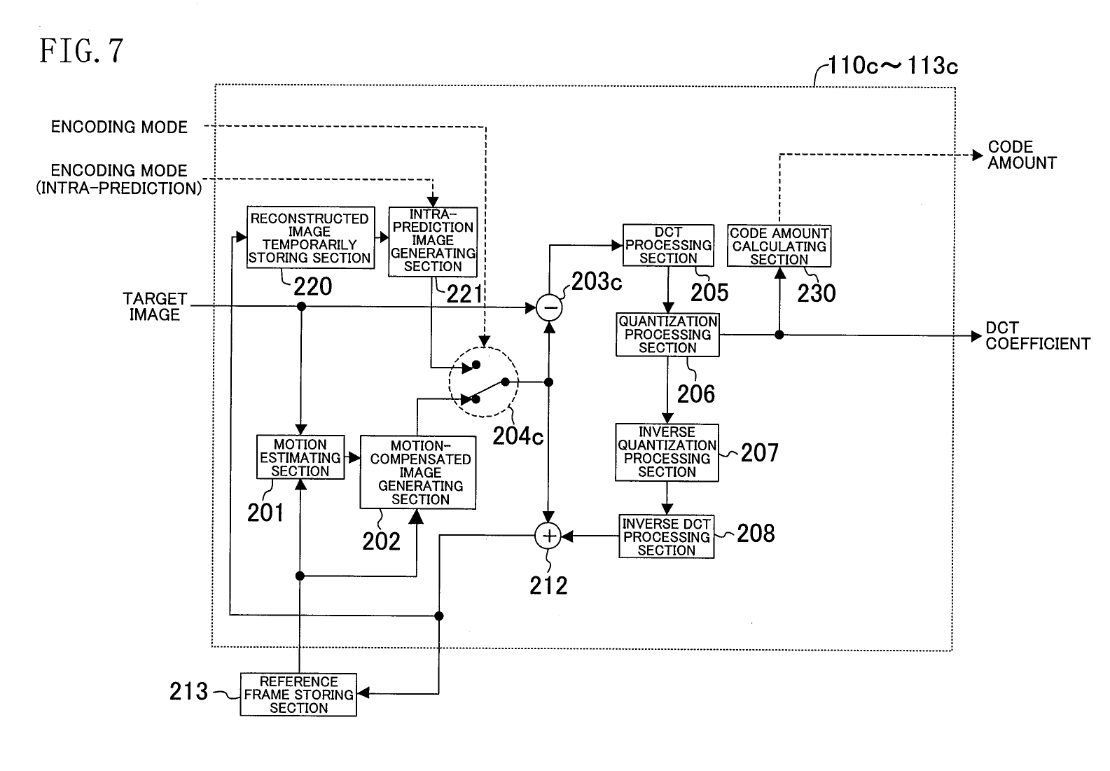

FIG. 6 is a block diagram showing an encoding process device 100c comprising an encoding mode determining section 120 for determining an intra-prediction mode which provides a smallest code amount. FIG. 7 shows a configuration of each of a first encoding section 2-1 (110c), a second encoding section 2-2 (111c), a third encoding section 2-3 (112c), . . . , and an n-th encoding section 2-n (113c) of FIG. 6.

In FIG. 7, when an externally designated encoding mode is intra-encoding, an intra-prediction image generating section 221 uses surrounding blocks stored in a reconstructed image temporarily storing section 220 to generate an intra-prediction image of the designated encoding mode (intra-prediction mode), and outputs the intra-prediction image to an encoding mode selecting section 204c. Since the encoding mode is the intra-encoding mode, the selecting section 204c selects the intra-prediction image output from the intra-prediction image generating section 221, and outputs the intra-prediction image to a subtraction section 203c. The subtraction section 203c generates a difference image between an externally input target image and its intra-prediction image, and outputs the difference image to the DCT processing section 205.

In this case, as shown in FIG. 6, the encoding section 2-1 (110c) to the encoding section 2-n (113c) perform processes in different intra-prediction modes. An intra-prediction mode is determined based on the code amounts of streams finally generated. Thereby, an encoding process can be performed while invariably selecting an intra-prediction mode which provides a smallest code amount.

Among the moving image compression-encoding techniques, such as, representatively, MPEG-4AVC/H.264, is motion compensation in which a plurality of reference frames are used. The present invention can also be used to determine the reference frames. The motion compensation using a plurality of reference frames means that, as a frame used in motion compensation, any frame can be selected from several frames that have been completely encoded.

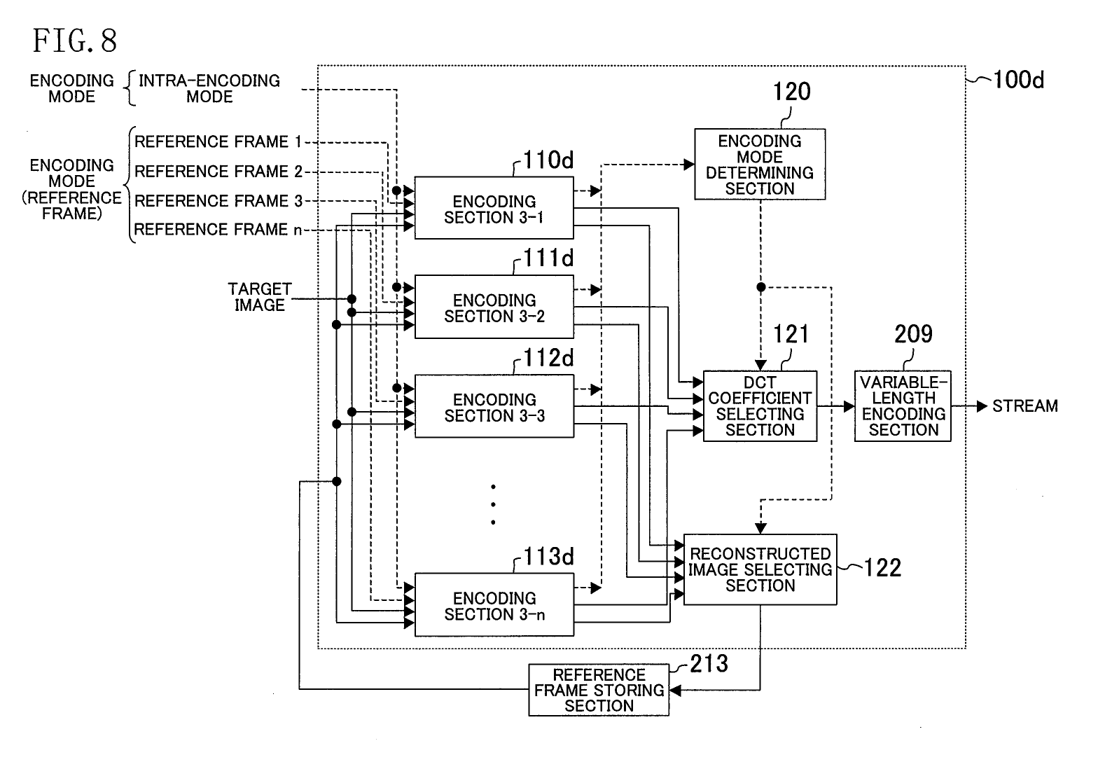

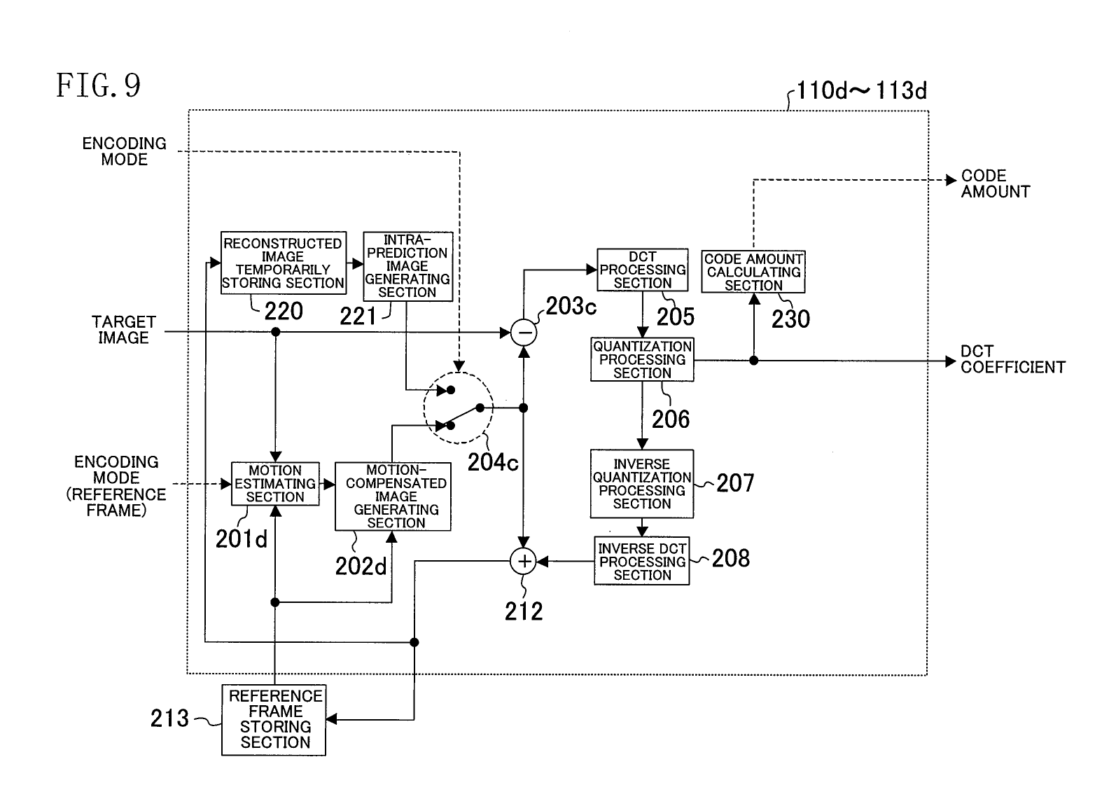

FIG. 8 is a block diagram showing an encoding process device 100d including an encoding mode determining section 120 that determines a reference frame that provides a smallest code amount. FIG. 9 shows a configuration of each of a first encoding section 3-1 (110d), a second encoding section 3-2 (111d), a third encoding section 3-3 (112d), and an n-th encoding section 3-n (113d) of FIG. 8. Since a reference frame is determined by a motion estimating section 201d, reference frames are directly designated and input to the motion estimating sections 201d from the outside of the encoding sections 110d to 113d. A motion-compensated image generating section 202d receives the result of the motion estimating section 201d, generates a motion-compensated image from the reference frame, and outputs the motion-compensated image to the encoding mode selecting section 204c.

In this case, if the encoding section 3-1 (110d) to the encoding section 3-n (113d) are caused to perform a motion compensation process using different reference frames as shown in FIG. 8, it is possible to select a reference frame that provides a smallest code amount, from the resultant code amounts obtained using the plurality of reference frames.

Also, in a moving image compression-encoding technique, such as, representatively, MPEG-4AVC/H.264, a block size for motion compensation can be changed on a macroblock-by-macroblock basis. The present invention is also applicable to determination of the block size for motion compensation. As previously described, the block size for motion compensation includes 16×16, 8×16, 16×8, 8×8, and the like.

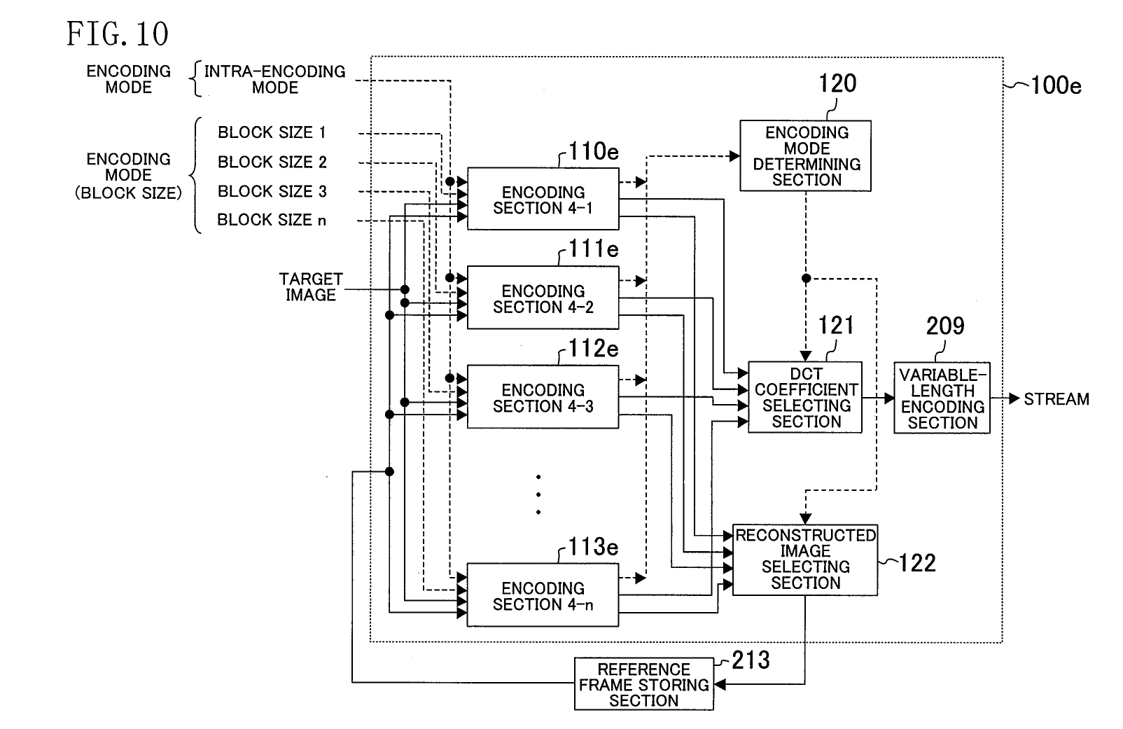

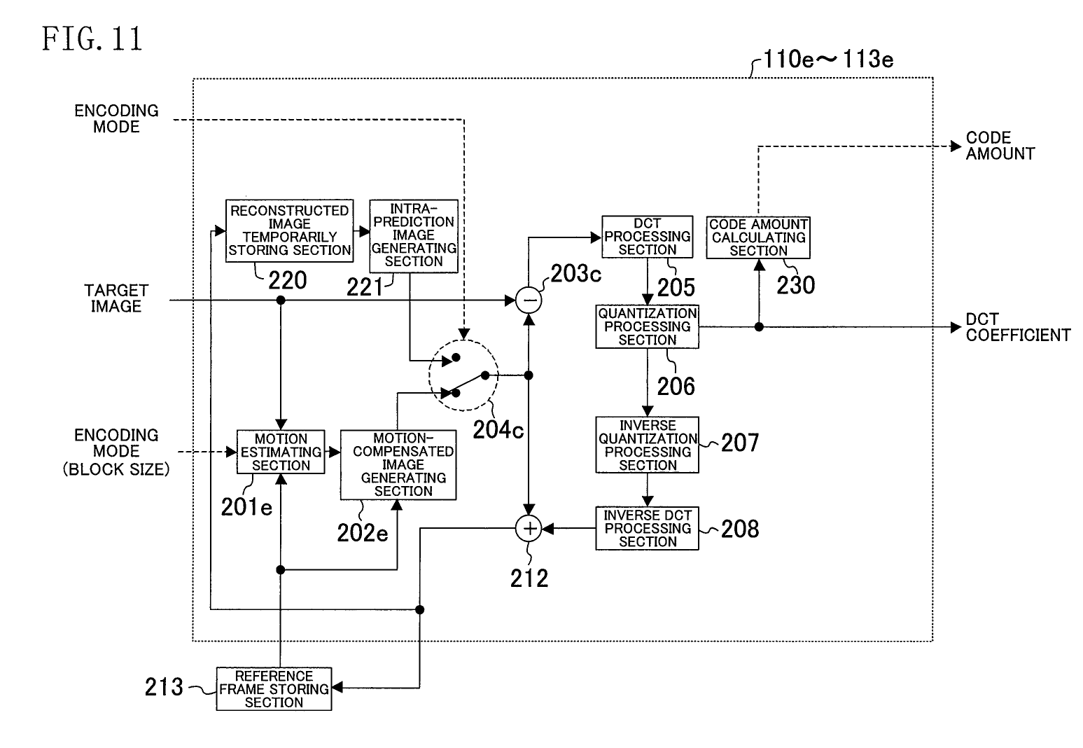

FIG. 10 is a block diagram showing an encoding process device 100e that includes an encoding mode determining section 120 for determining a block size for motion compensation that provides a smallest code amount. FIG. 11 shows a configuration of each of a first encoding section 4-1 (110e), a second encoding section 4-2 (111e), a third encoding section 4-3 (112e), and an n-th encoding section 4-n (113e) of FIG. 10. Since the block size for motion compensation is determined by a motion estimating section 201e, the block size for motion compensation is directly designated and input to the motion estimating section 201e from the outside of the encoding sections 110e to 113e. The motion-compensated image generating section 202e receives the result of the motion estimating section 201e, generates a motion-compensated image from the reference frame, and outputs the motion-compensated image to the encoding mode selecting section 204c.

In this case, if the encoding sections 4-1 (110e) to the encoding section 4-n (113e) are caused to perform a motion compensation process using different block sizes for motion compensation as shown in FIG. 10, a reference frame that provides a smallest code amount can be selected from the resultant code amounts obtained using the plurality of motion compensation block sizes.

It is well known that frame encoding types mainly include I-picture, P-picture, and B-picture in moving image compression-encoding, such as, representatively, MPEG. In MPEG-4AVC/H.264, a picture can be divided into one or a plurality of slices, and an encoding type (I-slice/P-slice/B-slice) can be determined for each slice. For P-pictures (P-slices) and B-pictures (B-slices), the “intra-encoding mode” and the “inter-encoding mode” can be selected and changed for each macroblock. For I-pictures (I-slices), however, the “intra-encoding mode” needs to be used in all macroblocks, which is defined in the standards.

Under these conditions, in a device, such as the encoding process device 100 of FIG. 3, that performs a process where the first encoding section 110 and the second encoding section 111 are set to be in the “intra-encoding mode” and the “inter-encoding mode”, respectively, a process no longer needs to be performed during an I-picture (I-slice) process in the second encoding section 111 that is set to be in the “inter-encoding mode”.

When an I-picture (I-slice) is processed, the “intra-encoding mode” can be designated for both the first and second encoding sections 110 and 111, and the quantization values of the quantization processing sections 206 in the encoding sections 110 and 111 can be changed to different values. For example, the “intra-encoding mode” is designated for the first encoding section 110, and α is designated for the quantization value of the quantization processing section 206 in the first encoding section 110. On the other hand, the “intra-encoding mode” is designated for the second encoding section 111, and β is designated for the quantization value of the quantization processing section 206. These quantization values α and β mean Q-parameters for controlling a compression ratio and, for example, take a value of 1 to 31 in MPEG-4.

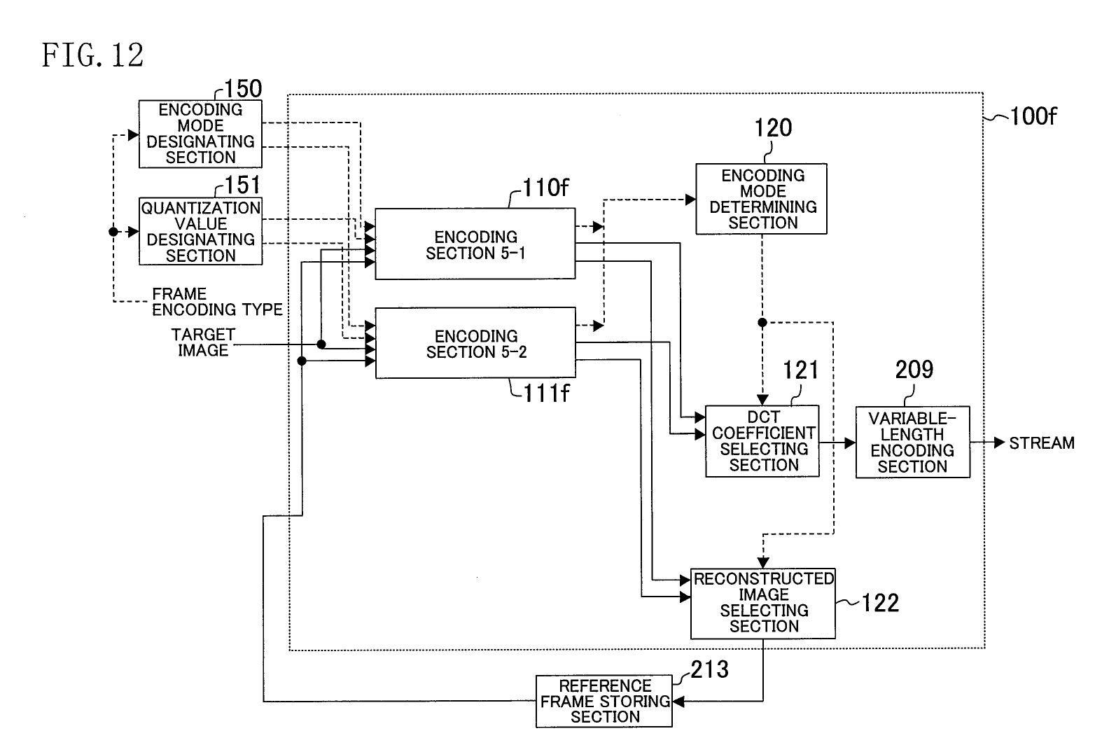

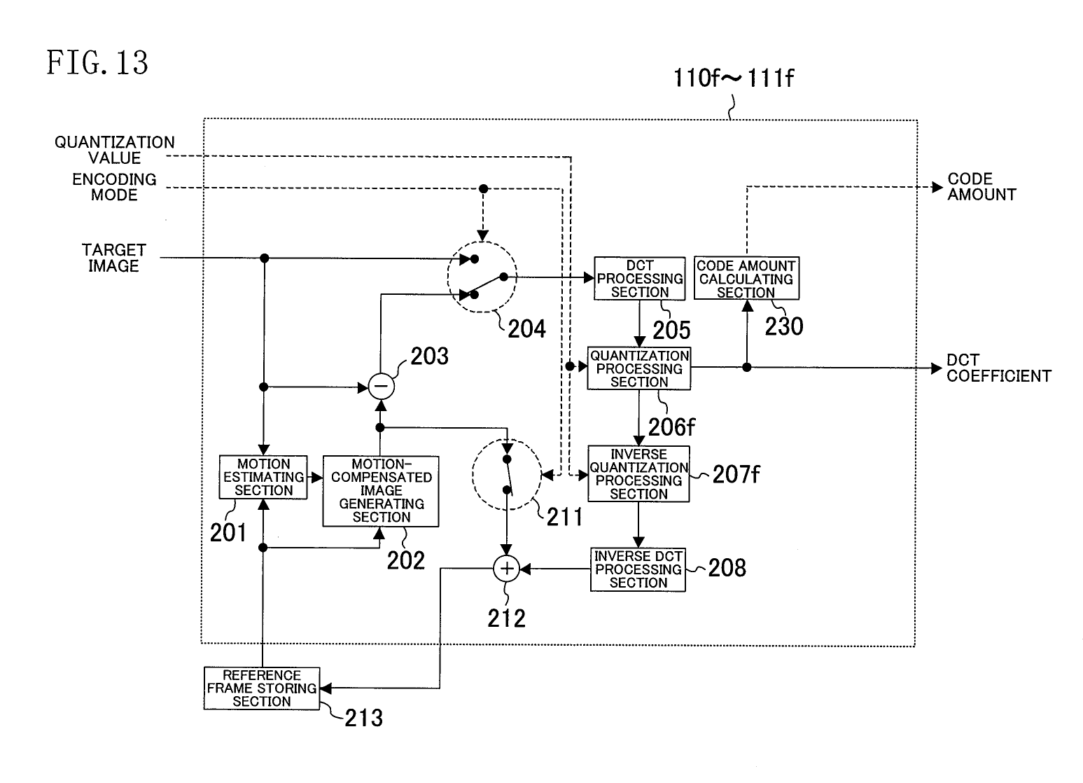

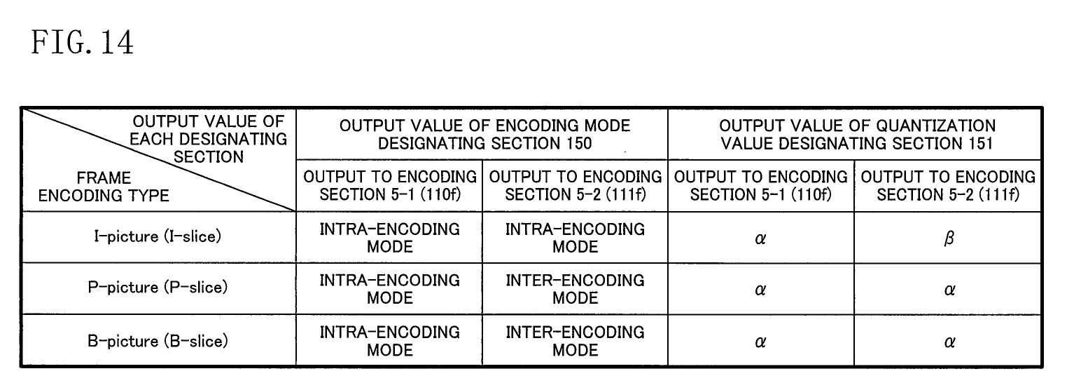

FIG. 12 is a block diagram showing an encoding process device 100f that achieves an adaptive quantization value. FIG. 13 shows a configuration of each of a first encoding section 5-1 (110f) and a second encoding section 5-2 (111f) of FIG. 12. The quantization values are directly designated and input to a quantization processing section 206f and an inverse quantization processing section 207f from the outside of the encoding sections 110f and 111f. FIG. 14 is a diagram showing a relationship between frame encoding types and quantization values.

The encoding process device 100f of FIG. 12 is configured to generate streams having different compression ratios using the encoding sections 5-1 (110f) and the encoding section 5-2 (111f). In addition, an encoding mode designating section 150 adaptively changes an encoding type in accordance with a frame encoding type as shown in FIG. 14. Similarly, a quantization value designating section 151 adaptively designates a quantization value in accordance with a frame encoding type as shown in FIG. 14. Thereby, an inter-encoding mode process, which is not used for I-pictures (I-slices), is effectively used, so that intra-encoding can be achieved with a small error from a target code amount.

As described above, a compression ratio is determined based on a quantization value. For example, when an excessively large amount of codes is generated in a p-th frame, a process in which a compression ratio is increased so as to suppress generation of codes to cancel the excess of the p-th frame (a quantization value is changed) is typically performed in a (p+1)-th frame. However, it is not possible to determine how much the quantization value is changed to do so unless, actually, the quantization value is set, an encoding process is performed, and a code amount is investigated. It is well known that an approximate guideline value may be calculated from the quantization value of the previous frame, the amount of codes generated in the previous frame, and a target code amount of the next frame, to determine the quantization value of the next frame. However, the thus-calculated quantization value of the next frame does not necessarily lead to the target amount of codes. In this case, by performing encoding using two candidate quantization values, such as a and B described above, a code amount closer to the target value can be achieved, resulting in a more correct control of the amount of codes.

Note that a plurality of configurations for encoding mode determination of FIGS. 1 and 2, intra-prediction mode determination of FIGS. 6 and 7, reference frame determination of FIGS. 8 and 9, determination of a block size for motion compensation of FIGS. 10 and 11, and the like can be combined to obtain a plurality of mode determination effects. For example, by combining encoding mode determination of FIGS. 1 and 2, and intra-prediction mode determination of FIGS. 6 and 7, it is possible to determine an encoding mode and an intra-prediction mode that provide a smallest code amount.

Also, for example, when only intra-encoding is performed in the encoding section 110 for which the intra-encoding mode is designated as shown in FIG. 3, a portion that is used only for the inter-encoding process can be removed from an implementation, resulting in a reduction in size. In the encoding section of FIG. 2, a portion that is used only for the inter-encoding process mainly includes the motion estimating section 201, the motion-compensated image generating section 202, the subtraction section 203, the encoding mode selecting section 204, the motion-compensated image switching section 211, and the addition section 212.

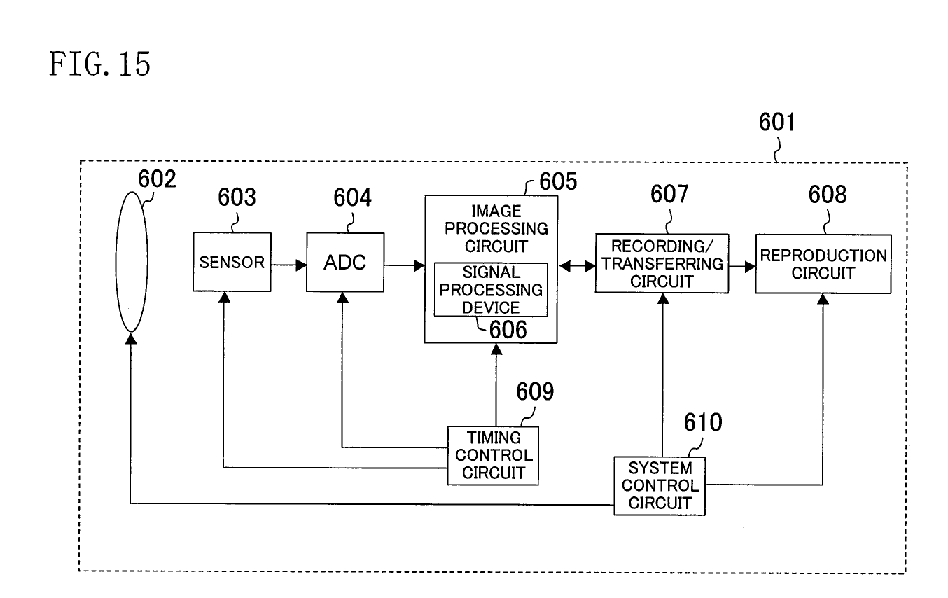

FIG. 15 is a block diagram showing a configuration of an imaging system 601 (e.g., a digital still camera (DSC)) employing the encoding process device of the present invention. In FIG. 15, a signal processing device 606 is any one of the encoding process devices of the above-described embodiments of the present invention.

According to FIG. 15, an image light entering through an optical system 602 is imaged on a sensor 603. The sensor 603, which is driven by a timing control circuit 609, accumulates and converts the imaged image light into an electrical signal (photoelectric conversion). An electrical signal read out from the sensor 603 is converted into a digital signal by an analog-to-digital converter (ADC) 604, and the resultant digital signal is then input to an image processing circuit 605 comprising the signal processing device 606. The image processing circuit 605 performs image processing, such as a Y/C process, an edge process, an image enlargement/reduction process, a compression/decompression process using the present invention, and the like. The signal that has been subjected to image processing is recorded or transferred into a medium by a recording/transferring circuit 607. The recorded or transferred signal is reproduced by a reproduction circuit 608. The whole imaging system 601 is controlled by a system control circuit 610.

With the configuration of FIG. 15, it is expected that a higher level of image quality of image processing can be achieved by optimal determination of an encoding mode.

Note that image processing in the signal processing device 606 of the present invention is not limited to a signal based on image light imaged on the sensor 603 via the optical system 602, and is applicable to, for example, a case where an image signal that is input as an electrical signal from the outside of the device is processed.

As described above, the encoding process method and the encoding process device of the present invention can correctly and invariably select an encoding mode which provides a smallest code amount when an encoding mode is determined from a plurality of encoding modes, and therefore, are useful as an apparatus having a function of taking a moving image, a technique for creating or using image contents, and the like.

What is claimed is:

1. An encoding process method for determining an encoding mode from a plurality of encoding modes that are provided in image compression, the method comprising the steps of:
generating quantized DCT coefficients in each of the plurality of encoding modes, and calculating a code amount of a stream to be generated from the DCT coefficients;
determining, from all of the plurality of encoding modes, an encoding mode providing a smallest code amount;
selecting the DCT coefficients of the determined encoding mode; and
variable-length encoding the selected DCT coefficients.

2. The encoding process method of claim 1, wherein
the plurality of encoding modes include an intra-encoding mode and an inter-encoding mode.

3. The encoding process method of claim 1, wherein
the plurality of encoding modes include two or more encoding modes in which an intra-encoding process is performed in different intra-prediction modes.

4. The encoding process method of claim 1, wherein
the plurality of encoding modes include two or more encoding modes in which an inter-encoding process is performed using different block sizes for motion compensation.

5. The encoding process method of claim 1, wherein
the plurality of encoding modes include two or more encoding modes in which an inter-encoding process is performed using different reference frames.

6. The encoding process method of claim 2, wherein
the plurality of encoding modes are switched, depending on a frame encoding type.

7. The encoding process method of claim 6, wherein
for a P-picture or a P-slice, or a B-picture or a B-slice, an intra-encoding mode and an inter-encoding mode are designated for the plurality of encoding modes, and
for an I-picture or an I-slice, two intra-encoding modes in which an encoding process is performed using different set parameters are designated for the plurality of encoding modes.

8. The encoding process method of claim 7, wherein
the different parameters are different quantization values.

9. An encoding process device for determining an encoding mode from a plurality of encoding modes that are provided in image compression, the device comprising:
a plurality of encoding sections for receiving a target image to be encoded and an image of a reference frame to be used for encoding, performing a DCT process and a quantization process in different encoding modes, and outputting DCT coefficients, a code amount of a stream to be generated from the DCT coefficients, and a reconstructed image;
an encoding mode determining section for determining an encoding mode providing a smallest code amount from the code amounts calculated by the plurality of encoding sections;
a DCT coefficient selecting section for selecting the DCT coefficients of the encoding mode determined by the encoding mode determining section, from the DCT coefficients output from the plurality of encoding sections;
a variable-length encoding section for receiving the DCT coefficients selected by the DCT coefficient selecting section, and performing a variable-length encoding process with respect to said DCT coefficients to generate a stream, and outputting the stream; and
a reconstructed image selecting section for selecting the reconstructed image of the encoding mode determined by the encoding mode determining section, from the reconstructed images output from the plurality of encoding sections, and storing said reconstructed image to a reference frame storing section.

10. The encoding process device of claim 9, wherein
each of the plurality of encoding section does not include a variable-length encoding section, and the variable-length encoding section alone is provided in the encoding process device.

11. The encoding process device of claim 9, wherein
the encoding modes input to the plurality of encoding sections include an intra-encoding mode and an inter-encoding mode.

12. The encoding process device of claim 9, wherein
the encoding modes input to the plurality of encoding sections include two or more encoding modes in which an intra-encoding process is performed in different intra-prediction modes.

13. The encoding process device of claim 9, wherein
the encoding modes input to the plurality of encoding sections include two or more encoding modes in which an inter-encoding process is performed using different block sizes for motion compensation.

14. The encoding process device of claim 9, wherein
the encoding modes input to the plurality of encoding sections include two or more encoding modes in which an inter-encoding process is performed using different reference frames.

15. The encoding process device of claim 9, wherein
each of the plurality of encoding sections performs the quantization process, and the code amount calculating process of calculating the code amount of a stream to be generated from the DCT coefficients, in process block-level pipelines.

16. The encoding process device of claim 9, wherein
each of the plurality of encoding sections performs the DCT process, the quantization process, and the code amount calculating process of calculating the code amount of a stream to be generated from the DCT coefficients, in block-level pipelines.

17. An imaging system comprising:
an image processing circuit having the encoding process device of claim 9;
a sensor for converting image light into an image signal;
an optical system for imaging incident image light onto the sensor; and
a converter for converting the image signal into digital data and outputting the digital data to the image processing circuit.

18. A signal process system comprising:
an image processing circuit having the encoding process device of claim 9; and
a converter for receiving an image signal having an analog value, converting the image signal into digital data, and outputting the digital data to the image processing circuit.
